(19) United States
(12) Patent Application Publication
(10) Pub. No.: US 2006/0134590 A1
(43) Pub. Date: Jun. 22, 2006

(54) Video-based music learning tool

(76) Inventors: Timothy Huffman, Cumming, GA (US); Andrew Morton, Atlanta, GA (US)

Correspondence Address: GREENBERG-TRAURIG, 1750 TYSONS BOULEVARD, 12TH FLOOR, MCLEAN, VA, 22102, US

(21) Appl. No.: 11/259,753

(22) Filed: Oct. 27, 2005

Related U.S. Application Data
(60) Provisional application No. 60/622,173, filed on Oct. 27, 2004.

(51) Int. Cl. G09B 5/00

(52) U.S. Cl. 434/307 A

(57) ABSTRACT

A method and system are disclosed for providing a video-based song-learning tool for teaching students to play songs accurately. A song is divided into natural music segments such as intro, verse, chorus, bridge and outro. An interface is provided to allow selection of a music segment to be played. An instructional video is provided for the song in a manner whereby, for each music segment, video content from which to learn the song is presented synchronously with the original artist's audio recording.

This application claims the benefit of U.S. Provisional Patent Application No. 60/622,173 filed Oct. 27, 2004 entitled “Video-Based Music Learning Tool, the entire disclosure of which is incorporated herein by reference.

### SUMMARY OF THE INVENTION

The invention provides a unique and innovative video-based song-learning tool created for teaching music students, musicians, or music lovers (collectively, “students”) how to completely and accurately play their favorite songs.

In accordance with a preferred embodiment of the invention, a song is divided into two or more natural music segments such as intro, verse, chorus, bridge, and outro. Instructional videos of each song segment are provided to present the student with an audio-visual archive of content from which to learn the song. Along with the song segment videos, also included is a video performance of the complete song in sync with the original artist's recording playing in the background. The student can store the video on multiple computers or devices and enjoy the freedom to learn the song at their own pace whenever and wherever they please.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIGS. 1-9 show screen shots illustrating the learning tool of the invention in its preferred embodiment.

FIGS. 10-11 show views illustrating a novel footswitch remote useful in connection with the learning tool of the invention.

### DETAILED DESCRIPTION OF THE PREFERRED EMBODIMENT

Reference will now be made in detail to the preferred embodiments of the present invention, examples of which are illustrated in the accompanying drawings.

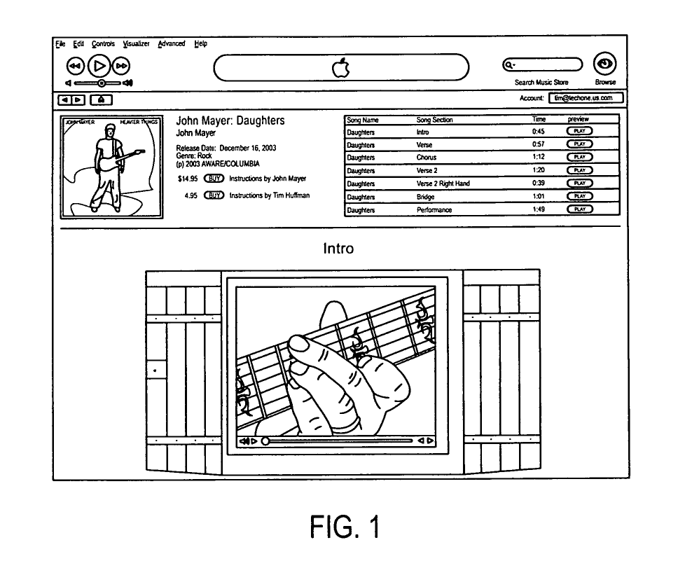

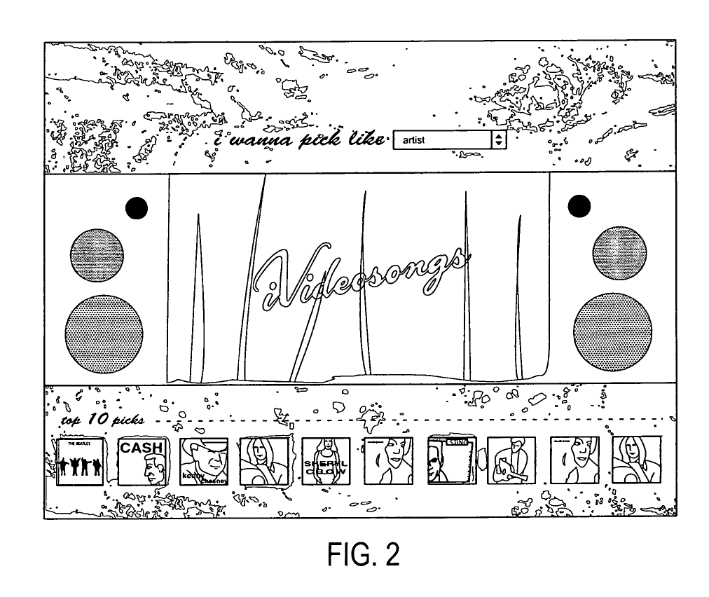

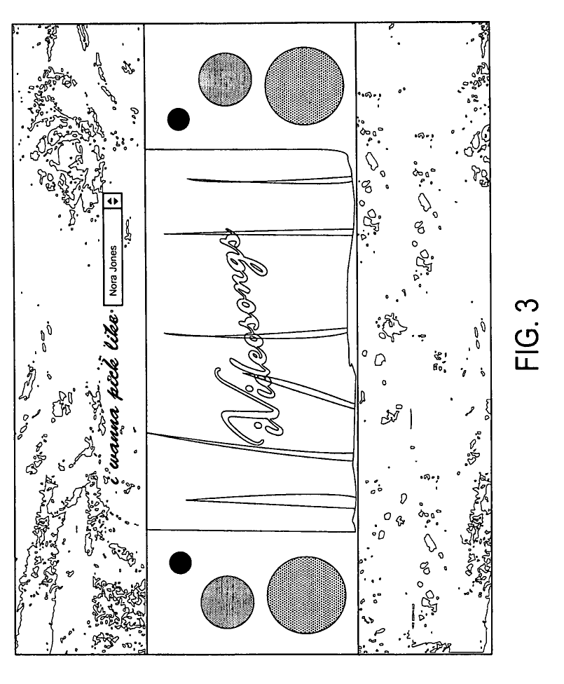

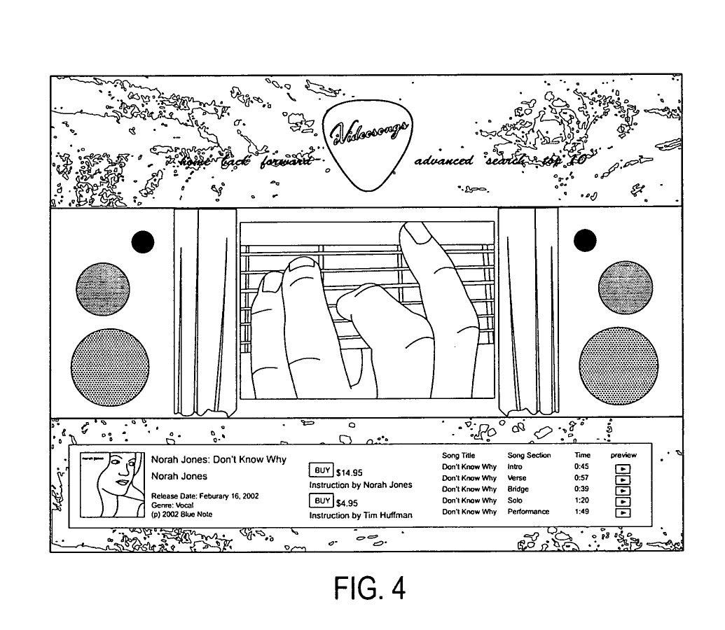

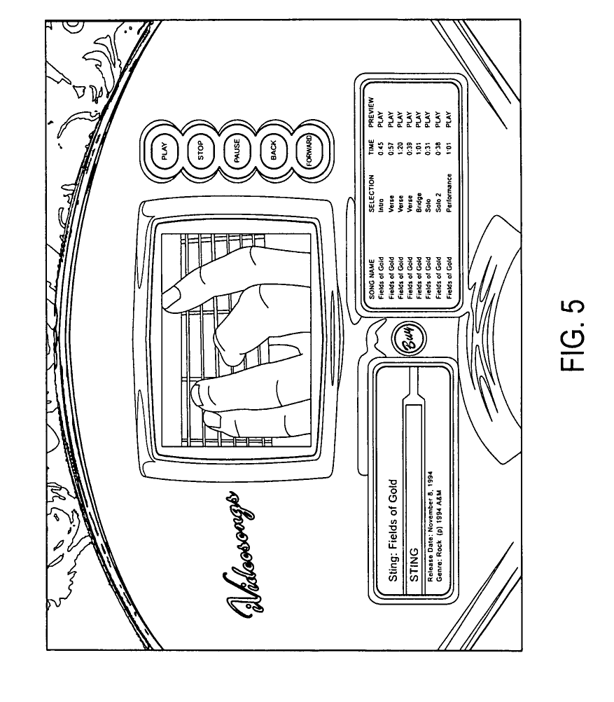

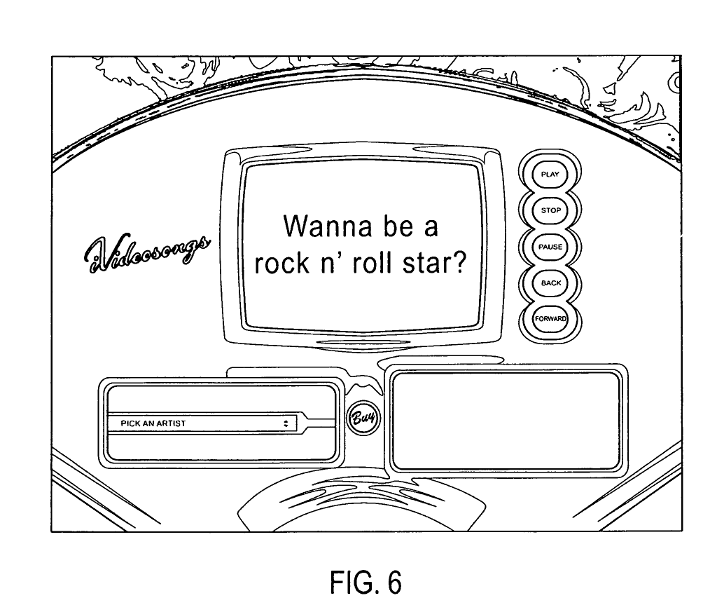

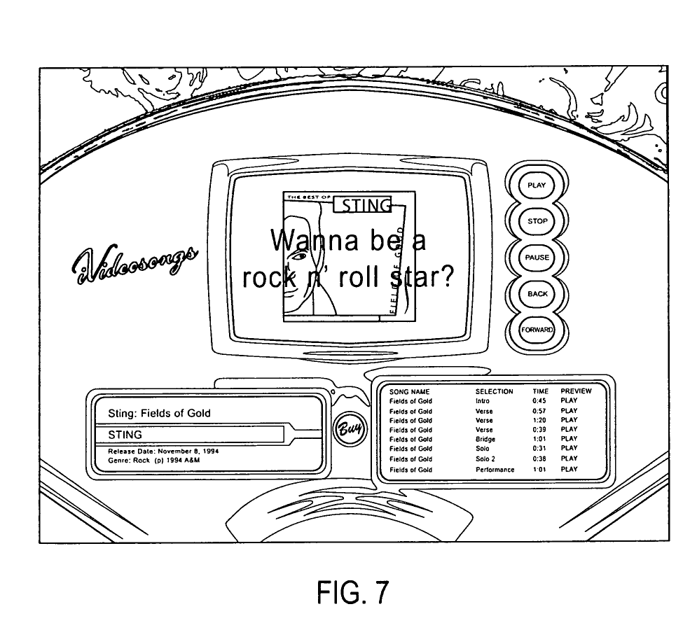

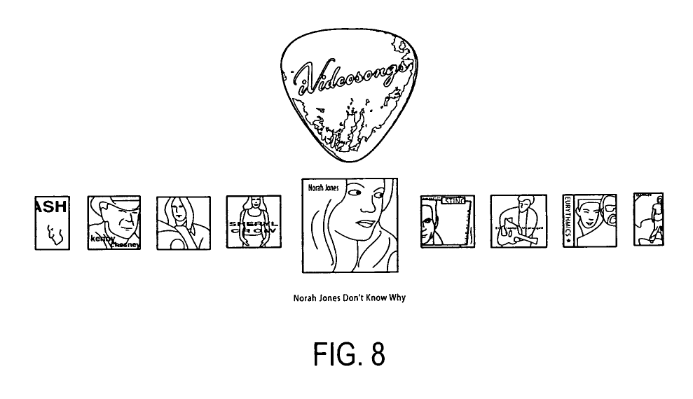

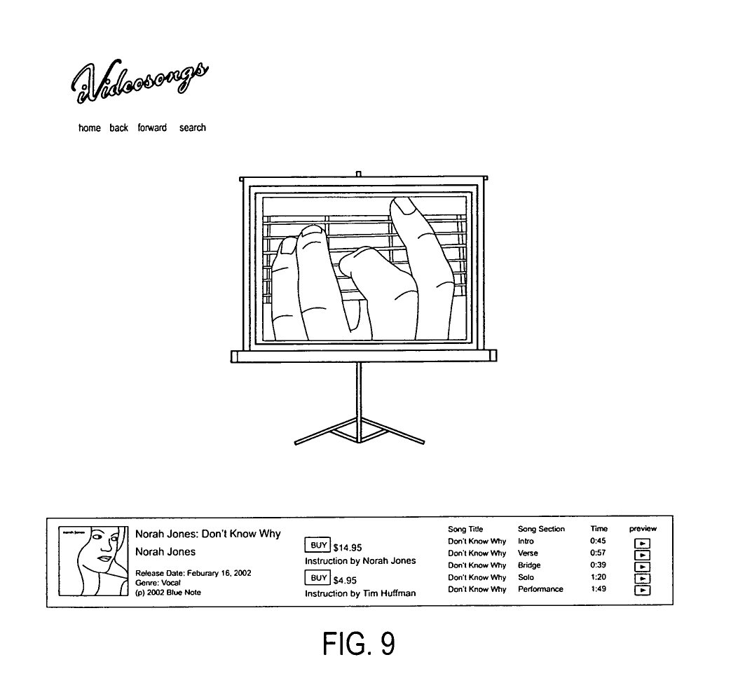

With reference to FIGS. 1-9, the invention in its preferred embodiment provides a software-implemented video-based song-learning tool for teaching music students, musicians, or music lovers how to completely and accurately play their favorite songs. It has been recognized that people remember 20% of what they hear, 40% of what they read, and 80% of what they see. The invention provides a means to learn any song via a combination of visual, written and audio learning aids.

Instructional videos of each song segment are provided to present the student or other user with an audio-visual archive of content from which to learn the song. The invention preferably divides a song into natural music segments; intro, verse, chorus, bridge. Along with the song segment videos, also included is a video performance of the complete song in sync with the original artist's recording playing in the background.

Subscribers may purchase a song or group of songs on any copy-protected media such as DVD, VHS, or downloaded or streamed software. In embodiments where the instructional videos are provided in the form of downloaded or streamed software, the video may be compressed and/or encoded using a suitable format, including, e.g., QUICKTIME available from Apple Computer Corporation of Cupertino, Calif., or compression CODECs such as MPEG, MPEG2, and MPEG4. The video may be encoded for playback in a browser by encoding the content and the interface using a program such as FLASH, which is available from Macromedia, Inc. of San Francisco, Calif.

A student may access the system of the invention via a computer with broadband internet access or T.V. with a DVD player or VCR. Media such as DVDs containing the instructional lessons of the invention may be sold commercially as stand-alone products, and such sales may be made via in-store kiosks. Orders for custom-burned mixes of songs may be received and filled via a website. The student can store the video on multiple computers or devices and enjoy the freedom to learn the song at their own pace whenever and wherever they please.

Once a subscriber logs in, the subscriber chooses a song to learn. A search can be performed to seek content by song title, artist, skill level, genre or instructor. A format can then be chosen. Such formats include, e.g., On Line Streaming, DVD, and Video.

Each song is broken into musical sections according to the recording. For example, a song may be comprised of intro, verse, chorus, and outro sections. In summary, each musical section of the song is presented separately, and then the entire song is played in time with the original recording in the background. The student can practice each piece independently and move on to the next piece when ready. Each song is then available for instant refresh.

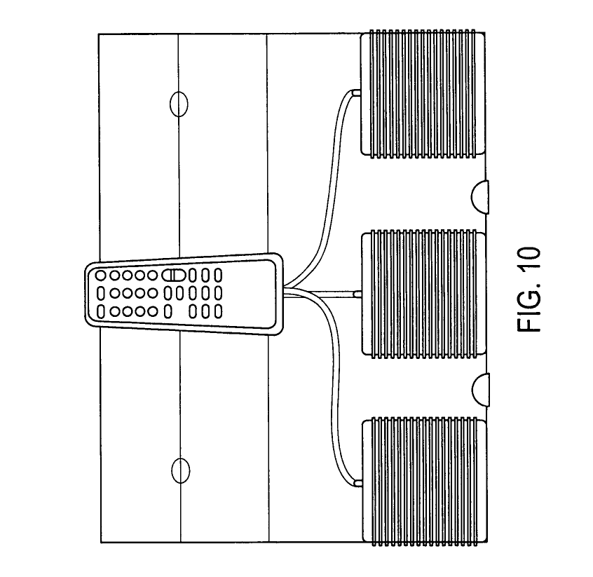

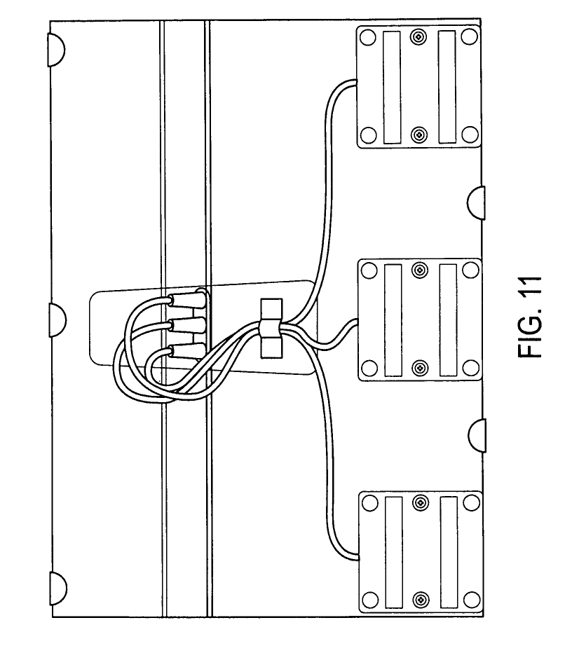

With reference to FIGS. 10-11, a novel infrared or radio frequency footswitch remote may be provided for use in conjunction with or separately from the learning tool of the invention. The footswitch translates switch closures into standard infrared or rf remote control signals, which are then used to control a playback device. For example, if the playback device is a DVD player, the footswitch can be used by a student to start, stop, advance, or rewind the instructional video without having to remove his hands from the instrument.

Among the significant advantages of the invention are the following. The songs are broken down by song segment and presented visually, thereby providing improved learning in a manner which is controllable by the student. Content can be stored on multiple digital devices. The performance version of the video can be synchronized with the original recording artist's audio recording. In some cases, the original artist or the artist's representative musician will be the video instructor. The audio-video player allows for frame-by-frame forward or rewind viewing, start-stop looping and audio mix controls to adjust the instruction audio volume and the volume of the original artist's recording. The product may be sold via a direct sales web site, multiple web portals and/or retail outlets. Related diagrams are available to be printed or downloaded. All content has the highest possible level of accuracy. All royalties owed to artists, publishers and record companies are paid. The invention may be provided in the form of a web site that enables music students to learn how to accurately play their favorite songs via video. The user can refer back to the video whenever needed. The invention can provide a learning experience free of sheet music or tablature to decipher. A library of songs is provided for selection by the subscriber. A subscriber can request any other song and it is then made part of the library. Subscribers may purchase custom transcriptions or lessons quoted on a per piece basis.

While the invention has been particularly shown and described with reference to a preferred embodiment thereof, it will be understood by those skilled in the art that various changes in form and details may be made therein without departing from the spirit and scope of the invention. For example, the invention may be practiced in software or hardware, or a combination thereof.

1. A method of providing a video-based song-learning tool for teaching students to play songs accurately, comprising:
dividing a song into natural music segments comprising at least two from the group consisting of: intro, verse, chorus, bridge and outro;
providing an interface which allows selection of a music segment to be played; and,
providing an instructional video for said song in a manner whereby, for each said music segment, video content from which to learn the song is presented synchronously with the original artist's audio recording.

2. The method of providing a video-based song-learning tool in accordance with claim 1, wherein said interface, said video content, and said original artist's recording are provided on removable storage media.

3. The method of providing a video-based song-learning tool in accordance with claim 2, wherein said removable storage media is a DVD.

4. The method of providing a video-based song-learning tool in accordance with claim 1, wherein said interface, said video content, and said original artist's recording are provided via downloaded or streamed software.

5. The method of providing a video-based song-learning tool in accordance with claim 1, wherein said video content comprises video of an instrument being played.
